(19) United States
(12) Patent Application Publication
(10) Pub. No.: US 2017/0271088 A1
(43) Pub. Date: Sep. 21, 2017

(54) THREE-DIMENSIONAL ELECTRODE ON DYE-SENSITIZED SOLAR CELL AND METHOD FOR MANUFACTURING THE SAME

(71) Applicants: Kookheon Char, Seoul (KR); Sanghyuk Wooh, Seoul (KR); Yong Soo Kang, Seoul (KR); Hyunsik Yoon, Seoul (KR)

(72) Inventors: Kookheon Char, Seoul (KR); Sanghyuk Wooh, Seoul (KR); Yong Soo Kang, Seoul (KR); Hyunsik Yoon, Seoul (KR)

(21) Appl. No.: 15/490,518

(22) Filed: Apr. 18, 2017

Related U.S. Application Data
(62) Division of application No. 13/909,702, filed on Jun. 4, 2013, now abandoned.

(30) Foreign Application Priority Data
May 2, 2013 (KR) 10-2013-0049643

(51) Int. Cl. H01G 9/20

(52) U.S. Cl. CPC H01G 9/209; H01G 9/2031; H01G 9/2059; Y02E 10/542; Y02P 70/521

(57) ABSTRACT

The present invention relates to a photoelectrode for a dye-sensitized solar cell including inorganic nanoparticles, wherein a three-dimensional pattern is formed on the surface of the photoelectrode. The three-dimensional photoelectrode for a dye-sensitized solar cell according to the present invention has a micrometer-sized pattern and thus exhibits an improved light absorption caused by a total reflection and a increased light path.

### CROSS-REFERENCE TO RELATED APPLICATIONS

This application is a divisional application of U.S. patent application Ser. No. 13/909,702, filed Jun. 4, 2013, which claims priority under 35 U.S.C. §119 to Korean Patent Application No. 10-2013-0049643 filed on May 2, 2013, in the Korean Intellectual Property Office, each of which is incorporated by reference herein in its entirety.

### TECHNICAL FIELD

The invention relates to a three-dimensional photoelectrode for a dye-sensitized solar cell and a method for manufacturing the same, and more specifically to the three-dimensional pattern including inorganic nanoparticles on the surface of photoelectrode with high light absorption efficiency.

### BACKGROUND

Renewable energy resources have gained a great deal of attention due to the ever-increasing energy demand, the shortage of fossil fuels and the growing interest in ecofriendly energy resources. Among various kinds of renewable energy sources, solar energy has been regarded as a good candidate because the sunlight as the unlimited energy source can be utilized using solar cells.

A dye-sensitized solar cell contains a redox electrolyte and produce electricity as dye molecules chemically adsorbed on the surface thereof absorb sunlight and emit electrons. The dye-sensitized solar cell has a simple configuration wherein the electrolyte is filled between a photoelectrode composed of specific dye adsorbed nanoparticles, and a counter electrode. When sunlight passes through a glass substrate and reaches the dye, the dye generates electrons. The electrons flow through the nanoparticles toward a transparent electrode which produces electricity. A variety of inorganic and organic materials are used as the dye. The electrolyte transports the electrons back to the dye. Since the energy conversion efficiency of the dye-sensitized solar cell is proportional to the amount of electrons generated by light absorption, development of a photoelectrode allowing adsorption of more dye molecules is required to generate more electrons.

Light absorbance generally decreases as the film thickness of a light absorbing active layer decreases, resulting in low energy conversion efficiency. There have been many trials to efficiently harvest light in order to compensate for lack of light absorption due to the reduction in the thickness of the photoelectrode. In particular, the light trapping strategy is quite useful to improve the optical conversion efficiency of thin film photovoltaic devices having limited film thickness such as dye-sensitized solar cells (DSCs) and organic photovoltaics (OPVs). For example, inverse opal nanostructures, scattering layers on top of the light absorption layer and surface plasmonics with metallic nanostructures have been developed for effectively trapping incident light inside the photoelectrode of a DSC. Also, nanopatterned photoelectrodes obtained from etched transparent conducting glasses and nanoimprinted neutral paste on the light absorption layer have been introduced recently (S.-H. Han, S. Lee, H. Shin, H. S. Jung, Adv. Energy Mater. 2011, 1, 546, S. Ito, S. M. Zakeeruddin, R. Humphry-Baker, P. Liska, R. Charvet, P. Comte, M. K. Nazeeruddin, P. Pechy, M. Takata, H. Miura, S. Uchida, M. Grazel, Adv. Mater. 2006, 18, 1202, M. D. Brown, T. Suteewong, R. S. S. Kumar, V. D'Innocenze, A. Petrozza, M. M. Lee, U. Wiesner, H. J. Snaith, Nano Lett. 2011, 11, 438).

The conventional photoelectrode structure shown in FIG. 1 has a scattering layer formed on a photoelectrode, which is used to effectively trap the light passing through the photoelectrode. However, this has the problem that the thickness of the photoelectrode is increased. In particular, in the recently esteemed solid dye-sensitized solar cell, the insertion of the scattering layer leads to a decrease of device efficiency due to slow charge transport.

### SUMMARY

Since the previous approaches have some limitations such as electron recombination and low dye adsorption due to increased thickness of the photoelectrode, a light trapping technique without an additional scattering layer increasing the thickness of the photoelectrode is needed in order to absorb more light, in a dye-sensitized solar cell.

The present invention provides a micro-sized three-dimensional patterned photoelectrode for a dye-sensitized solar cell including inorganic nanoparticles and a method for manufacturing the same.

In one general aspect, the present invention provides a photoelectrode for a dye-sensitized solar cell including inorganic nanoparticles, wherein a three-dimensional pattern is formed on the surface of the photoelectrode.

The three-dimensional pattern may be a regular shape. Specifically, the three-dimensional regular shape may be a shape of a lens, a pillar, a pyramid, a inversed pyramid or a prism.

The three-dimensional pattern may be an irregular shape. Specifically, the three-dimensional irregular shape may bee a randomized pyramid with irregular size.

The inorganic nanoparticles may be one or more selected from a group consisting of TiO₂, ZnO, SnO₂, WO₃, CdSe, CdS and GaAs.

The inorganic nanoparticles may have a diameter of 5-100 nm.

The three-dimensional photoelectrode may further include a scattering layer thereon.

The scattering layer may include inorganic nanoparticles.

The inorganic nanoparticles of the scattering layer may have a diameter of 100-1000 nm.

The scattering layer may have a thickness of 1-10 μm.

In another aspect, the present invention provides a method for manufacturing a three-dimensional photoelectrode for a dye-sensitized solar cell. Specifically, the present invention provides a method for manufacturing a micro-sized three-dimensional photoelectrode including nanoparticles by imprinting an inorganic nanoparticle paste.

Specifically, the method for manufacturing a photoelectrode for a dye-sensitized solar cell according to the present invention includes: (1) preparing a mold of a three-dimensional pattern; (2) coating an inorganic nanoparticle paste on a conductive substrate; (3) imprinting the mold of a three-dimensional pattern on the coated inorganic nanoparticle paste; (4) forming a three-dimensional patterned nanoparticle layer by annealing the mold of a three-dimensional pattern imprinted inorganic nanoparticle paste at 20-100° C.; (5) removing the mold of a three-dimensional pattern from the three-dimensional patterned nanoparticle layer; and (6) treating the three-dimensional patterned nanoparticle layer at about 200° C. or higher.

The mold may be poly(dimethylsiloxane) (PDMS), poly(urethane acrylate) (PUA) or perfluoropolyether (PFPE).

The three-dimensional pattern may be a regular shape. Specifically, the three-dimensional regular shape may be a shape of a lens, a pillar, a prism, a pyramid or a inversed pyramid.

The three-dimensional pattern may be an irregular shape. Specifically, the three-dimensional irregular shape may be a shape of a randomized pyramid with irregular size.

When preparing the mold of a three-dimensional pattern, if the pattern is a regular shape, the mold may be prepared by photolithography or micromachining. Specifically, a mold having a lens or pillar shape may be prepared by photolithography and a mold having a prism, pyramid or inversed pyramid shape may be prepared by micromachining

When preparing the mold of a three-dimensional pattern, if the pattern is an irregular shape, the mold may be prepared by wet etching.

The inorganic nanoparticle paste may include one or more selected from a group consisting of TiO₂, ZnO, SnO₂, WO₃, CdSe, CdS and GaAs.

The inorganic nanoparticle paste may include nanoparticles having a diameter of about 5-100 nm.

The method for manufacturing a three-dimensional photoelectrode may further include, after (6), adding a scattering layer on the photoelectrode.

The step of adding the scattering layer may include: coating an inorganic nanoparticle paste on the three-dimensional nanoparticle layer; and treating the inorganic nanoparticle paste-coated three-dimensional nanoparticle layer at high temperature.

The scattering layer may include inorganic nanoparticles.

The inorganic nanoparticles of the scattering layer may have a diameter of 100-1000 nm.

The scattering layer may have a thickness of 1-10 μm.

Other features and aspects will be apparent from the following detailed description, drawings and claims.

### BRIEF DESCRIPTION OF THE DRAWINGS

The above and other objects, features and advantages of the present invention will become apparent from the following description of certain exemplary embodiments given in conjunction with the accompanying drawings, in which:

FIG. 1 is a cross-sectional view of an conventional dye-sensitized solar cell wherein a scattering layer is introduced on a photoelectrode;

FIG. 2 schematically shows a method for manufacturing a three-dimensional dye-sensitized solar cell according to the present invention invention;

FIG. 3 shows scanning electron microscopic (SEM) images of three-dimensional TiO₂ photoelectrodes according to the present invention [a: lens, b: pillar, c: prism, d: pyramid, e: inversed pyramid; scale bars: 1 μm (a), 10 μm (b, c, d, e)];

FIG. 4 shows magnified SEM images of three-dimensional TiO₂ photoelectrodes according to the present invention [a): pillar, b): prism, c): pyramid, d): inversed pyramid; scale bars: 500 nm];

FIG. 5 shows a photograph showing optical properties of two-dimensional and three-dimensional photoelectrodes on which N719 dye is adsorbed (a) along with reflection (b), transmission (c) and absorption (d) measurement results;

FIG. 6 shows photocurrent-voltage (J-V) characteristics of dye-sensitized solar cells having three-dimensional photoelectrodes according to the present invention;

FIG. 7 shows light paths in photoelectrodes [(a): two-dimensional flat, (b): three-dimensional pillar, (c): three-dimensional prism, (d): three-dimensional pyramid];

FIG. 8 shows a schematic illustration of a method for manufacturing a pyramid-patterned TiO₂ photoelectrode having a three-dimensional irregular shape by wet etching according to the present invention (a) along with SEM images thereof (b-d) [scale bars: 5 μm (b, c), 1 μm (d)];

FIG. 9 shows a cross-sectional view of a pyramid-patterned TiO₂ photoelectrode having a three-dimensional irregular shape wherein a scattering layer is introduced on the photoelectrode (a) along with an SEM image thereof [(b), scale bar: 5 μm], an image of ray tracing obtained using by an optical simulation tool (c) and photocurrent-voltage characteristics of the photoelectrode (d); and

FIG. 10 shows a flow chart illustrating a method for manufacturing a three-dimensional photoelectrode according to the present invention.

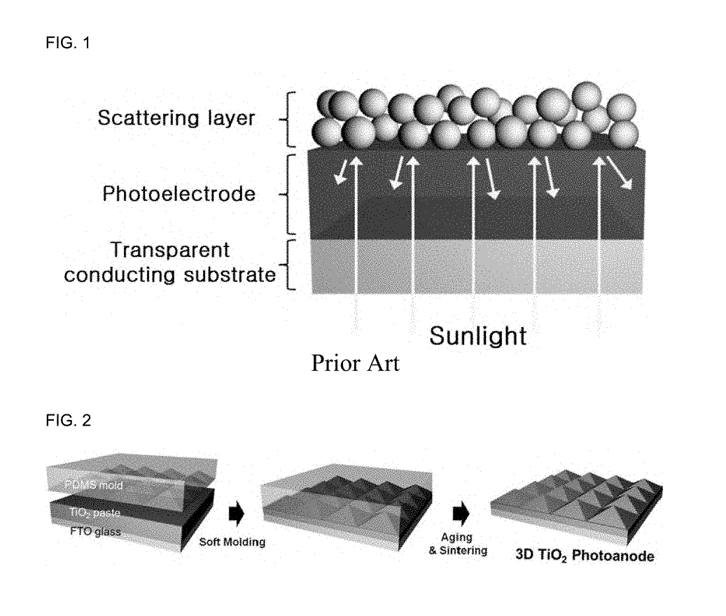

It should be understood that the appended drawings are not necessarily to scale, presenting a somewhat simplified representation of various preferred features illustrative of the basic principles of the invention. The specific design features of the invention as disclosed herein, including, for example, specific dimensions, orientations, locations and shapes, will be determined in part by the particular intended application and use environment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this invention will be thorough and complete, and will fully convey the scope of the present invention to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

Whereas the conventional flat, two-dimensional photoelectrode cannot utilize the light passing through the photoelectrode without being absorbed, a photoelectrode according to the present invention can utilize the unabsorbed light by inducing a total reflection on the surface of the three-dimensional photoelectrode. As a result, it provides a good light trapping effect, and a improved optical conversion efficiency of devices. Further, it can be manufactured in short time over a large area.

Accordingly, the present invention provides a three-dimensional photoelectrode for a dye-sensitized solar cell including inorganic nanoparticles which has a micrometer-sized pattern and thus exhibits effectively improved light absorption caused by a total reflection and a increased light path.

A method according to the present invention will be described referring to FIG. 2. The present invention provides a method for preparing a three-dimensional microstructure by soft imprinting an inorganic nanoparticle paste coated on a photoelectrode. This method is advantageous in that a uniform three-dimensional structure consisting of nanoparticles can be achieved very easily over a wide area. The processing time is very short, for example, the imprinting time is only several seconds and the aging time is about 10 minutes. The method can be easily applied to the conventional photoelectrode manufacturing process and allows economical production owing to the low cost of a PDMS mold.

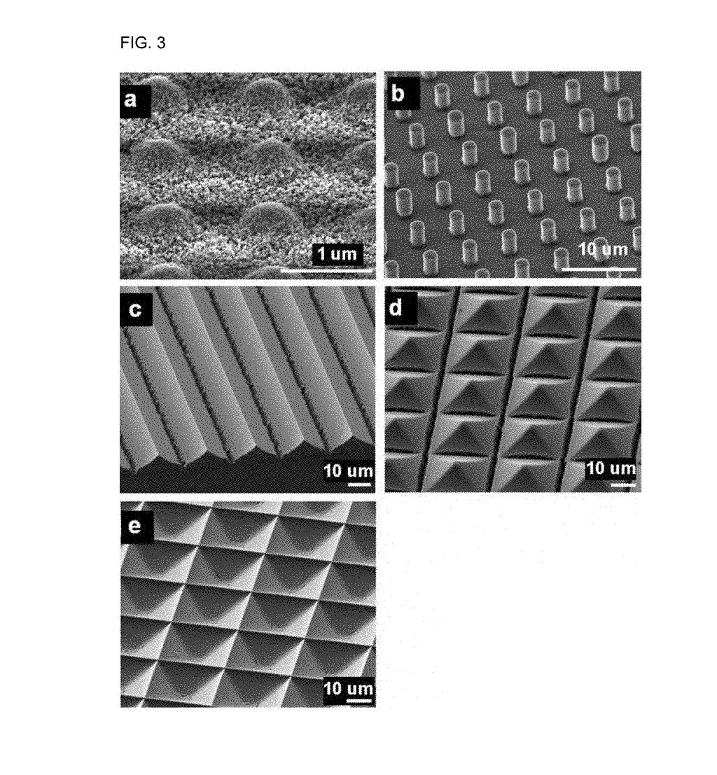

FIG. 3 shows scanning electron microscopic (SEM) images of photoelectrodes having three-dimensional patterns according to the present invention. (a) shows a lens-patterned TiO₂ photoelectrode (diameter 500 nm), (b) shows a pillar-patterned TiO₂ photoelectrode (diameter 2 μm, height 3.5 μm), (c) shows a prism-patterned TiO₂ photoelectrode (width 25 μm, height 11.5 μm), (d) shows a pyramid-patterned TiO₂ photoelectrode (width 25 μm, height 12 μm) and (e) shows an inversed pyramid-patterned TiO₂ photoelectrode (width 25 μm, height 12 μm).

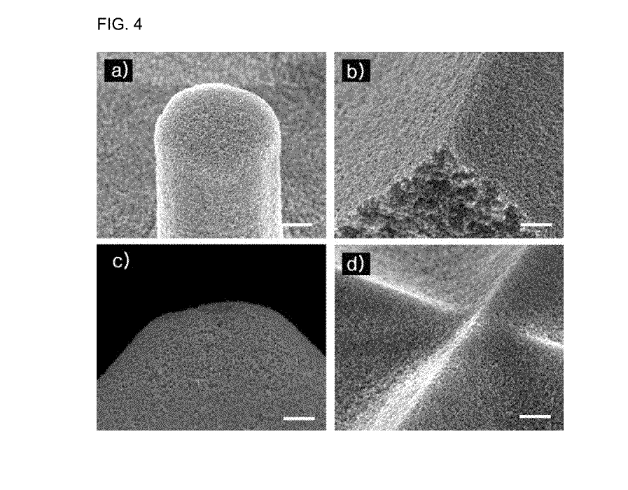

FIG. 4 shows that the patterned photoelectrodes are well-defined and uniform with TiO₂ nanoparticles arranged over large area.

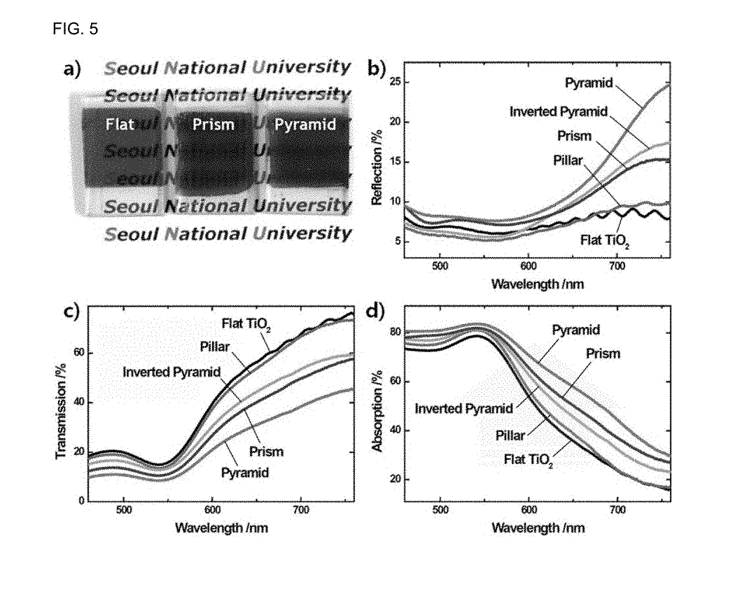

FIG. 5 shows that, although the same amount of dye was adsorbed by the photoelectrodes, the three-dimensional photoelectrodes according to the present invention absorb more light than the conventional two-dimensional flat photoelectrode, as can be seen from a darker shading (a). That is to say, the three-dimensional photoelectrodes have significantly enhanced light trapping and absorption capabilities. Among the three-dimensional photoelectrodes, the pyramid-patterned photoelectrode traps more light than the prism-patterned photoelectrode (d). UV/Vis absorption can be calculated from the measured transmission (T) and reflection (R) [Absorption (%)=100−T−R].

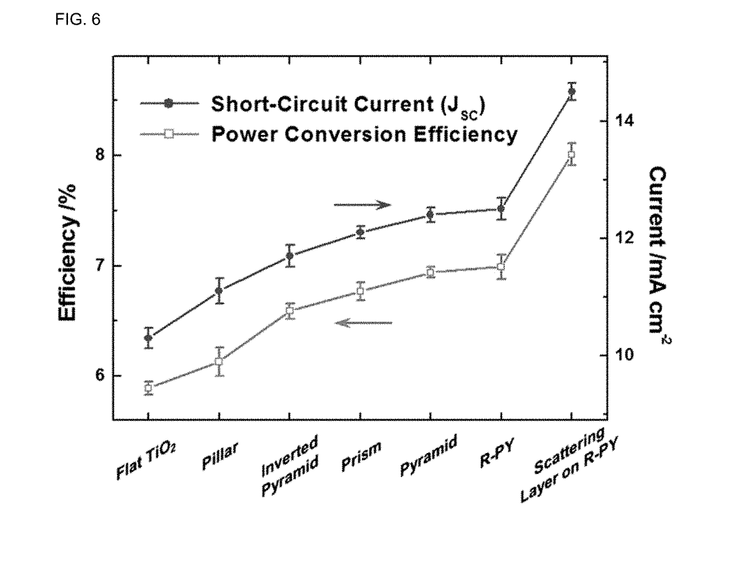

FIG. 6 shows the photocurrent-voltage (J-V) characteristics of dye-sensitized solar cells having various patterned photoelectrodes manufactured according to the present invention. The pyramid-patterned TiO₂ photoelectrode exhibits the highest photocurrent (J_{SC}) and power conversion efficiency (PCE) owing to the increased amount of trapped light.

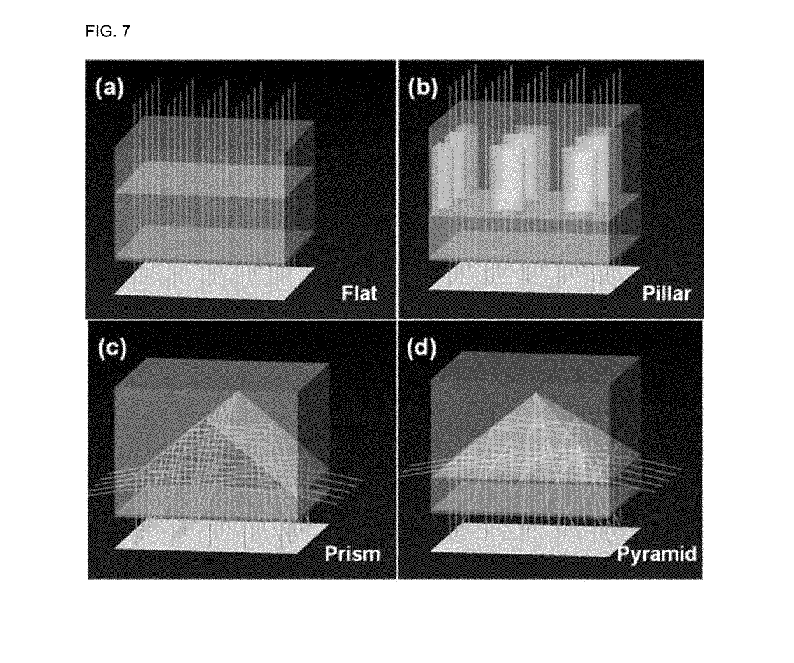

The light trapping effect of the differently patterned photoelectrodes is clearly seen from a simulation result obtained using LightTools, as shown in FIG. 7. For the optical simulation, TiO₂ nanostructures including electrolytes and dyes (electrolytes are included within the pores of the TiO₂ nanostructure) with refractive indices of 2.0 and 1.33 were used. The difference in refractive index leads to total reflection on the sloped facets of the pyramid-patterned TiO₂ photoelectrode and an incident light is effectively trapped inside the three-dimensional photoelectrode. In this aspect, optical path lengths of the different patterns were calculated by the ray tracing method, taking into account the dye adsorption by the Beer-Lambert law with reference transmittance (15% at 540 nm and 57% at 650 nm) at the flat two-dimensional photoelectrode.

Table 1 shows relative optical path lengths, which are the ratios of optical lengths in the patterned structures to that in the flat photoelectrode, and relative absorption data. The pyramid-patterned photoelectrode shows the highest absorption, which is proportional to the optical path length among the various geometries tested, due to the total reflection on the sloped facets. This experimental and simulation results demonstrating the effective light trapping capability due to the total internal reflection are in good agreement with the analysis result of a surface-treated silicon substrate. To compare the light trapping characteristics for different geometries such as two-dimensional flatness and three-dimensional pyramid and inversed pyramid, the inversed pyramid structure shows the highest path length enhancement. In the case of the dye-sensitized solar cells, since the incident light is illuminated on a transparent FTO substrate, the effect of the inversed pyramid in the silicon solar cells is the same as that for the upright pyramid-patterned photoelectrode.

TABLE 1

| | Wavelength (540 nm) | | Wavelength (650 nm) | |
|---|---|---|---|---|
| | | Relative | | Relative |
| | Relative | Path | Relative | Path |
| | Absorption [a] | Length [b] | Absorption | Length |
| Flat 2D Photoanode | 1 | 1 | 1 | 1 |
| Pillar | 1.03 | 1.005 | 1.08 | 1.01 |
| Inverse Pyramid | 1.03 | 1.05 | 1.27 | 1.57 |
| Prism | 1.04 | 1.10 | 1.41 | 1.76 |
| Pyramid | 1.06 | 1.16 | 1.62 | 1.89 |
| Scattering Layer | 1.18 | 1.21 | 2.04 | 2.17 |
| on Flat | | | | |
| Scattering Layer | 1.19 | 1.24 | 2.26 | 2.41 |
| on Pyramid | | | | |

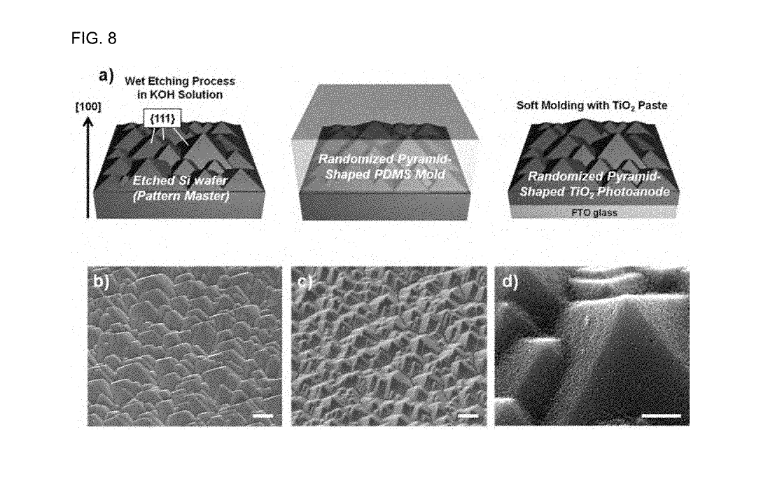

FIG. 8 shows a three-dimensional photoelectrode having an irregular shape according to another exemplary embodiment of the present invention. The photoelectrode may have a three-dimensional irregular shape.

Although the soft molding method is quite effective in fabricating three-dimensional structures at low cost over a large area, there still exists difficulties in preparing three-dimensional pattern masters due to a complicated semiconductor processing or a mechanical machining, which is also time-consuming and expensive. According to the present invention, the photoelectrode with high efficiency can be easily manufactured by the texturing of a silicon wafer by wet etching which is used as a master for PDMS replication. With PDMS replica molding, the present invention can fabricate the randomized pyramid-shaped TiO₂ photoelectrode, which have randomly distributed pyramids of different sizes on the surface that can be prepared from texturing of a crystalline silicon substrate by anisotropic wet etching.

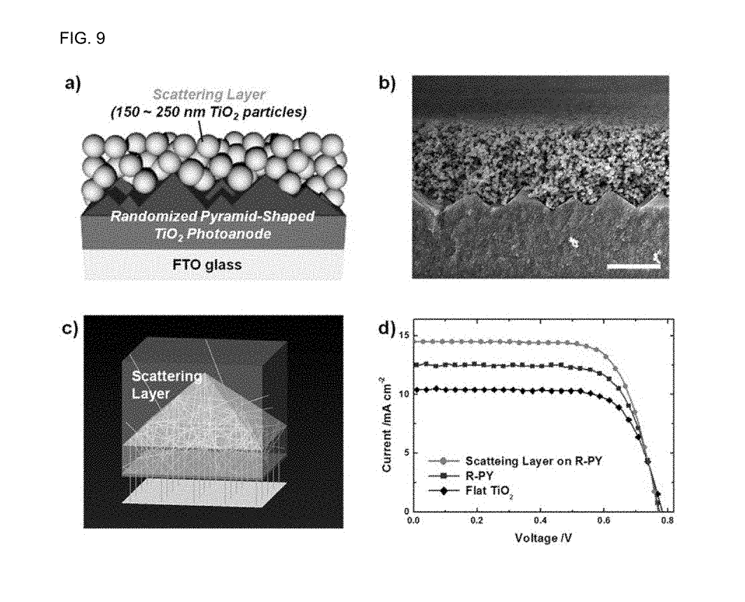

FIG. 9 shows a photoelectrode wherein a scattering layer is further formed on the randomized patterned photoelectrode (R-PY) with irregular shape. It is noted that the randomized patterned photoelectrode (R-PY) yields similar J_{SC} and PCE values when compared with the regularly arranged pyramid-patterned photoelectrode, despite the fact that it is fabricated by a much simpler and inexpensive wet etching process (Table 2).

TABLE 2

| | V_{OC} | J_{SC} | | Efficiency |
|---|---|---|---|---|
| | (V) | (mA cm⁻²) | FF | (%) |
| Flat TiO₂ | 0.78 | 10.3 | 0.73 | 5.89 |
| Pillar TiO₂ | 0.78 | 11.1 | 0.72 | 6.13 |
| Prism TiO₂ | 0.78 | 12.1 | 0.72 | 6.77 |
| Inverted Pyramid TiO₂ | 0.78 | 11.7 | 0.72 | 6.59 |
| Pyramid TiO₂ | 0.78 | 12.4 | 0.73 | 6.94 |
| R-PY [b] | 0.77 | 12.5 | 0.72 | 6.99 |
| R-PY with a Scattering Layer | 0.78 | 14.5 | 0.72 | 8.02 |

### EXAMPLE

Hereinafter, the present invention will be described in detail through an example. However, the following example is for illustrative purpose only and it will be apparent to those of ordinary skill in the art that the scope of the present invention is not limited by the example.

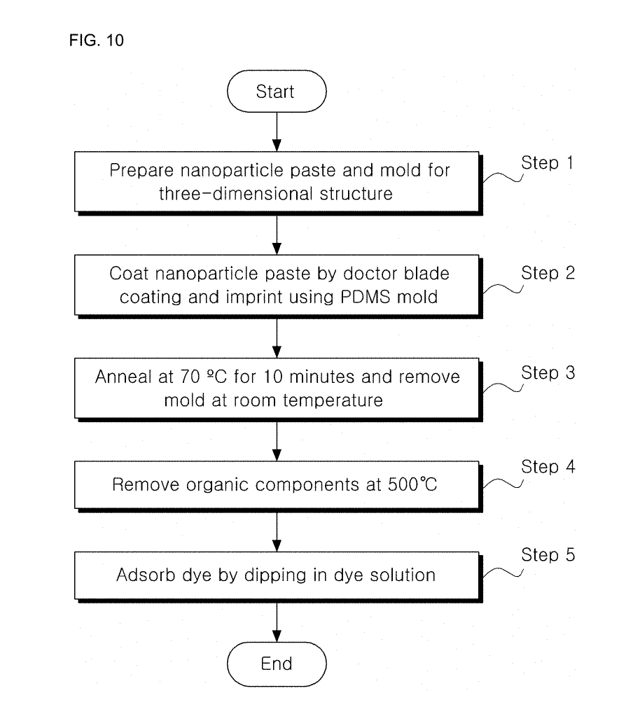

A method for manufacturing a three-dimensional photoelectrode according to the present invention will be described referring to FIG. 10. In this example, the photoelectrode and the dye-sensitized solar cell were manufactured using TiO₂ as inorganic nanoparticles, I⁻/I₃⁻ solution as an electrolyte and N719 dye as a dye.

Step1: Preparation of PDMS Molds for Three-Dimensional Structures

A master for a lens or pillar shape was produced by photolithography. A master for a prism or pyramid shape was produced by micromachining. A master for a randomized pyramid structure was produced by etching a silicon wafer immersed in KOH solution for 10 minutes.

A thermally curable liquid poly(dimethylsiloxane) (PDMS) prepolymer, was poured on the prepared master, spread uniformly, and cured at 80° C. to obtain a patterned three-dimensional PDMS mold. An inversed pyramid structure is prepared by twice replication. First, a liquid poly(urethane acrylate) (PUA) prepolymer, was used to form the pattern on a pyramid-shaped master. Then, PDMS prepolymer was cured on the patterned master to obtain a patterned PDMS mold.

Step 2: Nanoparticle Paste Coating and Imprinting

A paste including TiO₂ nanoparticles of about 20-50 nm was coated on a transparent conductive substrate by doctor blade coating or screen printing. First, an electron blocking layer was formed on FTO glass by spin coating 0.1 M of Ti(IV) bis(ethyl acetoacetato)-diisopropoxide dissolved in 1-butanol. A flat, two-dimensional TiO₂ photoelectrode was fabricated by doctor blade method with TiO₂ paste (DSL 18NR-T, Dyesol) on an FTO substrate (sheet resistance 8 Ωsq⁻¹, Pilkington). A paste of 150-250 nm anatase TiO₂ particles (WER2-O, Dyesol) was used as a scattering layer.

The three-dimensional PDMS mold prepared above was placed on the coated nanoparticle paste and then pressed. The doctor blade coated flat, two-dimensional TiO₂ paste was fabricated into a three-dimensional patterned structure by soft molding with the PDMS mold.

Step 3: Annealing and Removal of Mold

After evaporating solvent from the paste at 70° C. for 10 minutes, the mold is detached at room temperature.

Step 4: Treatment at High Temperature

The solidified three-dimensional TiO₂ photoelectrode on the conductive substrate was sintered at 500° C. for 15 min to entirely remove the organic components of the paste.

To maximize light trapping, a scattering layer is formed by doctor blade coating using a nanoparticle paste including TiO₂ nanoparticles of 100 nm or larger in size. Then, the organic components and the solvent are removed at 500° C.

Step 5: Dye Adsorption

The sintered TiO₂ photoelectrode was dipped in a solution of N719 dye (cis-bis(isothiocyanato)bis(2,2′-bipyridyl-4,4′-dicarboxylato)-ruthenium(II) bistetrabutyl ammonium, (Dyesol, 0.3 mM) in acetonitrile and tert-butanol (1:1 v/v) at 30° C. for 18 hours to adsorb the dye on the surface of the TiO₂ nanoparticles.

A dye-sensitized solar cell is manufactured as follows using the prepared three-dimensional photoelectrode. A Pt counter electrode is prepared by thermal decomposition of H₂PtCl₆ (0.01 M) in isopropyl alcohol solution spun cast on an FTO substrate at 500° C. for 15 minutes, and then two holes for electrolyte injection were made. The TiO₂ photoelectrodes were attached with the counter electrode using surlyn film (25 μm, Solaronix) which serves as a spacer between the two electrodes. A mixing solution of 1-methyl-3-propylimidazolium iodide (0.6 M), I₂ (0.05 M), lithium iodide (0.1 M), guanidinium thiocyanate (0.05 M), and 4-tert-butylpyridine (0.5 M) in acetonitrile is used as the electrolyte. This electrolyte was filled into the holes of the Pt counter electrode of a sandwich-structured cell by capillary force, and the holes were subsequently sealed with surlyn film and a cover glass.

Although a TiO₂ nanoparticle paste which is commercially available easily was used in this example, other metal nanoparticles such as ZnO, SnO, etc. may also be used to fabricate a three-dimensional photoelectrode. And, although a solution using I⁻/I₃⁻ as an electron transferer was used as the electrolyte, other liquid electrolytes based on cobalt, ferrocene, Se or polysulfide ions or polymer electrolytes, and solid electrolyte including 2,2′,7,7′-tetrakis(N,N-p-dimethoxy-phenylamino)-9,9′-spirobifluorene, polythiophene, may also be used. And, although N719 dye was used in this example, any inorganic or organic dye commonly used as sensitizer may also be used.

By providing a three-dimensional photoelectrode, the present invention allows more effective utilization of light by a dye-sensitized solar cell and thus leads to a increased photocurrent and a improved light conversion efficiency of the dye-sensitized solar cell. The method according to the present invention is simply and economically applicable to the conventional process.

Further, the present invention is applicable to all types of dye-sensitized solar cells, including a dye-sensitized solar cell which use a liquid electrolyte, a quasi-solid dye-sensitized solar cell which uses a polymer electrolyte and a solid dye-sensitized solar cell which uses a hole transporting material as an electrolyte.

While the present invention has been described with respect to the specific embodiments, it will be apparent to those skilled in the art that various changes and modifications may be made without departing from the spirit and scope of the invention as defined in the following claims.

What is claimed is:

1. A method for manufacturing a photoelectrode for a dye-sensitized solar cell, comprising:
preparing a mold of a three-dimensional pattern;
coating an inorganic nanoparticle paste on a conductive substrate;
imprinting the mold of a three-dimensional pattern on the coated inorganic nanoparticle paste;
forming a three-dimensional nanoparticle layer by annealing the mold of a three-dimensional pattern imprinted inorganic nanoparticle paste at 20-100° C.;
removing the mold of a three-dimensional pattern from the three-dimensional nanoparticle layer; and
treating the three-dimensional nanoparticle layer at 200° C. or higher.

2. A method for manufacturing a photoelectrode for a dye-sensitized solar cell according to claim 1, wherein the three-dimensional pattern is a regular shape.

3. A method for manufacturing a photoelectrode for a dye-sensitized solar cell according to claim 2, wherein the three-dimensional pattern is a shape of a lens.

4. A method for manufacturing a photoelectrode for a dye-sensitized solar cell according to claim 3, wherein the mold of the three-dimensional pattern is prepared by photolithography.

5. A method for manufacturing a photoelectrode for a dye-sensitized solar cell according to claim 3, wherein the mold of the three-dimensional pattern is prepared by wet etching.

6. A method for manufacturing a photoelectrode for a dye-sensitized solar cell according to claim 1, wherein the inorganic nanoparticle paste comprises one or more selected from a group consisting of TiO₂, ZnO, SnO₂, WO₃, CdSe, CdS and GaAs.

7. A method for manufacturing a photoelectrode for a dye-sensitized solar cell according to claim 1, wherein the inorganic nanoparticles have a diameter of 5-100 μm.

8. A method for manufacturing a photoelectrode for a dye-sensitized solar cell according to claim 1, which further comprises, after said treating the three-dimensional nanoparticle layer at 200° C. or higher, forming a scattering layer on the photoelectrode.

9. A method for manufacturing a photoelectrode for a dye-sensitized solar cell according to claim 8, wherein said forming the scattering layer comprises: coating an inorganic nanoparticle paste on the three-dimensional nanoparticle layer; and treating the inorganic nanoparticle paste coated three-dimensional nanoparticle layer at high temperature.
